(19) United States
(12) Patent Application Publication
(10) Pub. No.: US 2025/0083301 A1
(43) Pub. Date: Mar. 13, 2025

(54) INDOOR MOBILE ROBOT GLASS DETECTION AND MAP UPDATING METHOD BASED ON DEPTH IMAGE INPAINTING

(71) Applicant: BEIHANG UNIVERSITY, Beijing (CN)

(72) Inventors: Yong TAO, Beijing (CN); Yufang WEN, Beijing (CN); He GAO, Beijing (CN); Lian DUAN, Beijing (CN); Dongming HAN, Beijing (CN)

(21) Appl. No.: 18/888,557

(22) Filed: Sep. 18, 2024

Related U.S. Application Data
(63) Continuation of application No. PCT/CN2022/129900, filed on Nov. 4, 2022.

(30) Foreign Application Priority Data
Jan. 18, 2022 (CN) 202210052001.5

(51) Int. Cl. B25J 5/00; B25J 19/02; G01C 21/20; G01S 13/86

(52) U.S. Cl. CPC B25J 5/007; B25J 19/023; G01C 21/206; G01S 13/867

(57) ABSTRACT

The present invention provides an indoor mobile robot glass detection and map updating method based on depth image inpainting. The method comprises: first screening, based on laser radar intensity data, a region in which glass is suspected to be present; determining, based on an RGB image of the suspected region and by using a convolutional neural network, whether glass is really present; if glass is really present, extracting a glass region boundary, determining a defect point of a depth image, and performing depth information supplementing on the defect point based on the glass region boundary; and finally, performing plane sampling on the depth image, inpainting and updating a missing glass obstacle in an original map, and outputting a grid map for planning. Therefore, a problem, that the existing mapping algorithms and devices are prone to glass perception failure due to the characteristics of glass transmission, refraction, polarization, etc., affecting the map integrity and navigation safety, is solved. The present invention has advantages of a low system perception cost and a safe and stable navigation function.

### TECHNICAL FIELD

The present invention relates to the field of indoor mobile robots, and specifically, to an indoor mobile robot glass detection and map updating method based on depth image inpainting.

### BACKGROUND

In the field of service robots, indoor mobile robot related technologies are currently a hot topic in research and application. The research mainly focuses on map construction, positioning, navigation, and another aspect. In other word, the research focuses on solving problems of “where am I” and “where am I going” for a mobile robot. At present, a technology of a robot using laser radar and odometer information for simultaneous positioning and mapping in an unknown environment has become relatively mature. However, compared with a structured laboratory environment, an actual operating environment is often more complex and changeable.

When facing an indoor glass curtain wall, a partition, a glass door, and another object, a mobile robot system often has a problem of glass perception failure due to transmission, refraction, polarization, and another characteristic of glass. An established map includes a large quantity of voids and cannot effectively represent a glass obstacle, causing a safety risk to subsequent navigation planning work.

### SUMMARY

To solve a problem that based on an existing technology, a map created by a robot cannot show a glass obstacle, seriously affecting subsequent positioning and navigation planning work, the present invention provides an indoor mobile robot glass detection and map updating method based on depth image inpainting, including:
S1, processing laser radar information to obtain strength data, and screening, based on the strength data, a region in which glass is suspected to be present;
S2, selecting an image of an RGBD camera based on information of the region in which glass is suspected to be present, using a convolutional neural network to identify the image of the RGBD camera, and determining whether there is glass in the region, wherein absence of glass is defined as a first situation, and presence of glass is defined as a second situation;
S3, normally performing, when a result is the first situation, map updating without inpainting;
S4, determining, when the result is the second situation, a defect point type in depth data obtained by the RGBD camera, wherein using the defect point as a center, if a quantity of defect points of a same type in a neighboring region is less than or equal to a first threshold, it is determined that the defect point is a first-type defect point, or if a quantity of defect points of a same type in a neighboring region is greater than a first threshold, it is determined that the defect point is a second-type defect point;
S5, performing supplementing, when the defect point is the first-type defect point, by using median filtering, or first detecting, when the defect point is the second-type defect point, a defect edge and then calculating, based on a linear filtering idea, distance values around the defeat point to perform supplementing; and
S6, performing plane sampling on inpainted information to obtain reliable distance data, and outputting the distance data to a map updating step to obtain an inpainted new navigation map. Preferably, a method of screening the region in which glass is suspected to be present includes:
S1.1, defining a distance change threshold and a variance threshold;
S1.2, continuously calculating a difference between two pieces of data before and after in the returned distance data, searching for a timestamp of a distance difference, and recording laser radar data when the distance difference is greater than the distance change threshold;
S1.3, calculating a variance of the laser radar, and recording data exceeding the variance threshold; and
S1.4, setting a maximum length of a segment and dividing, based on time continuity, data points into a plurality of segments, that is, the segment in which glass is suspected to be present.

Preferably, RGBD image detection is introduced to a method of screening the region in which glass is suspected to be present and an RGB image is used to determine whether glass is present.

Preferably, a depth image inpainting algorithm is used in a method of screening the region in which glass is suspected to be present to obtain distance information of glass.

Preferably, steps of determining the defect point type include:
S4.1, first screening, after a depth matrix is obtained, a defect in a small scale, and recording coordinates of the defect point;
S4.2, for a noise point with a depth of 0, counting a quantity of non-zero values in a neighboring region, where the noise point with a depth of 0 is considered to be a defect if the quantity of non-zero values is greater than a specific threshold;
S4.3, for a void with uncertain depth data, counting a quantity of pieces of missing distance data in a neighboring region, wherein the void with uncertain depth data is considered to be a defect if the quantity of pieces of missing distance data is greater than a specific threshold; and
S4.4, for void and noise point defects, determining the defect point as the first-type defect point or the second-type defect point based on the quantity of defect points of the same type around the defect point.

Preferably, the quantity of defect points of the same type in the neighboring region of the first-type defect point is less than or equal to the first threshold, and the median filtering is used for distance supplementing.

Preferably, for the second-type defect point, a solution of inpainting the second-type defect point includes:
S5.1, to ensure an inpainting effect, taking distance values of 24 points in the neighboring region around the defect point according to an idea of the median filtering, where if there is a void around, the distance values of the 24 points are skipped, a median of the distance values is calculated, and the median is used to assign values to points in corresponding distance values to obtain the depth matrix;
S5.2, performing edge sharpening on the depth matrix;
S5.3, extracting boundary points from a sharpened depth matrix boundary;
S5.4, taking all points with missing distance data in the depth matrix, performing depth inpainting, and obtaining an average based on distances and distances to nearest boundary points; and
S5.5, supplementing average data to the depth matrix to obtain a final inpainted depth matrix.

Preferably, a solution of map information updating includes:
S6.1, selecting a minimum value in each column of the depth data to form a row vector, and performing dimension reduction processing on the inpainted depth matrix;
S6.2, obtaining a maximum value in the inpainted matrix, and calculating a current camera field-of-view range, wherein a field of view length is the maximum value in the inpainted matrix, and a field of view width and the field of view length form a trigonometric function relationship related to a lateral field of view angle;
S6.3, obtaining current pose information of a mobile robot in a world coordinate system; and
S6.4, calculating a position of an obstacle, and finally completing the map updating at the position.

Preferably, the laser radar information is obtained by a depth camera.

A computer-readable storage medium stores a computer program, and the computer program, when executed by a processor in a computing device, enables the computing device to perform any one of the methods.

In the present invention, only two devices, laser radar and an RGBD camera, are used to detect glass. The method includes: first screening, based on a laser radar intensity data variance, a region in which glass is suspected to be present; determining, based on an RGB image of the suspected region and by using a convolutional neural network, whether glass is really present; if glass is really present, extracting a glass region boundary, determining a defect point of a depth image, and performing depth information supplementing on the defect point based on the glass region boundary; and finally, performing plane sampling on the depth image, inpainting and updating a glass obstacle missing in an original map, and outputting a grid map for planning. Therefore, a problem, that the existing mapping algorithms and devices are prone to glass perception failure due to the characteristics of glass transmission, refraction, polarization, etc., affecting the map integrity and navigation safety, is solved. The present invention has advantages of a low system perception cost and a safe and stable navigation function.

### BRIEF DESCRIPTION OF THE DRAWINGS

To describe the technical solutions in embodiments of the present invention or in related art more clearly, the accompanying drawings required for describing embodiments or related art are briefly described below. Apparently, the accompanying drawings in the following description show merely some embodiments of the present invention, and a person of ordinary skill in the art may still obtain other drawings from these accompanying drawings without creative efforts.

FIG. 1 is a flowchart of an algorithm according to the present invention.

FIG. 2 is a schematic diagram of an algorithm according to the present invention.

FIG. 3 is an original picture obtained by a camera according to the present invention.

FIG. 4 is an example result of glass recognition using an RGB image according to the present invention.

FIG. 5 is an original picture obtained by a camera in an inpainted experiment according to the present invention.

FIG. 6 is an original depth image obtained by a camera according to the present invention.

FIG. 7 is a filtering result of a glass scene depth image according to the present invention.

FIG. 8 is a boundary extraction result of a glass scene depth image according to the present invention.

FIG. 9 is a depth image of a glass scene after inpainting according to the present invention.

FIG. 10 is a schematic diagram of a structural framework of a mobile platform according to the present invention.

FIG. 11 is a schematic diagram of an experiment-environment according to the present invention.

FIG. 12 is a preliminary result of establishing an experiment-environment map according to the present invention.

FIG. 13 is an inpainted and undated result of an experiment-environment map according to the present invention.

FIG. 14 is an original map path planning result according to the present invention.

FIG. 15 is a map path planning result after inpainting and update according to the present invention.

### DETAILED DESCRIPTION

To make the foregoing objectives, features, and advantages of the present invention clearer, the following further describes the present invention in detail with reference to the accompanying drawings and specific implementations. It should be noted that embodiments of the present invention and features in embodiments may be mutually combined in a case that no conflict occurs.

In the following description, many specific details are set forth to facilitate a full understanding of the present invention. However, the present invention may alternatively be implemented in another way different from those described herein. Therefore, a protection scope of the present invention is not limited to the specific embodiments disclosed below.

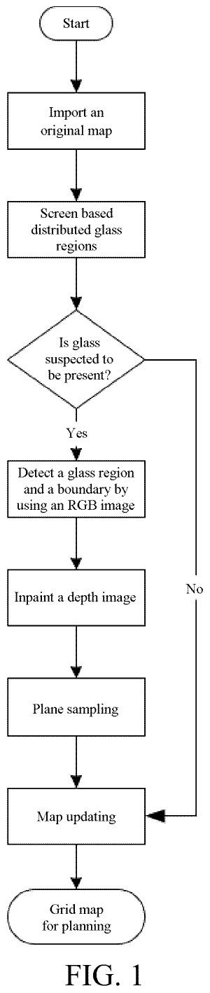

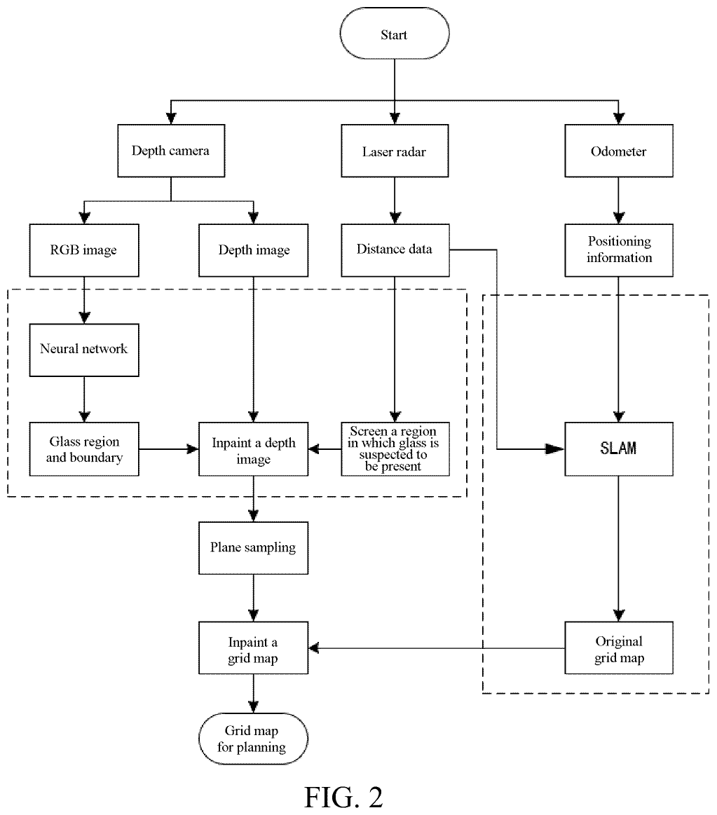

Embodiment 1: The present invention provides an indoor mobile robot glass detection and map updating method based on depth image inpainting, and a process of the method is as shown in FIG. 1. Specific steps are as follows:
S1: Process laser radar information to obtain strength data, and screen, based on the strength data, a region in which glass is suspected to be present;
S2: Select an image of an RGBD camera based on information of the region in which glass is suspected to be present, use a convolutional neural network to identify the image of the RGBD camera, and determine whether there is glass in the region, where absence of glass is defined as a first situation, and presence of glass is defined as a second situation;
S3: Normally perform, when a result is the first situation, map updating without inpainting;
S4: Determine, when the result is the second situation, a defect point type in depth data obtained by the RGBD camera, wherein using the defect point as a center, if a quantity of defect points of a same type in a neighboring region is less than or equal to a first threshold, it is determined that the defect point is a first-type defect point, or if a quantity of defect points of a same type in a neighboring region is greater than a first threshold, it is determined that the defect point is a second-type defect point;
S5, performing supplementing, when the defect point is the first-type defect point, by using median filtering, or first detecting, when the defect point is the second-type defect point, a defect edge and then calculating, based on a linear filtering idea, distance values around a pixel to perform supplementing; and
S6: Perform plane sampling on an inpainted depth image to obtain reliable distance data, and output the distance data to a map updating step to obtain an inpainted new map for planning.
the screening a region in which glass is suspected to be present includes:
S1.1: Define a distance change threshold and a variance threshold;
S1.2: Continuously calculate a difference between two pieces of data before and after in the returned distance data, search for a timestamp of a distance difference, and record laser radar data when the distance difference is greater than the distance change threshold;
S1.3: Calculate a variance of the laser radar, and record data exceeding the variance threshold; and
S1.4: Set a maximum length of a segment and divide, based on time continuity, data points into a plurality of segments, that is, the segment in which glass is suspected to be present.

The RGBD image detection is introduced and the RGB image is used to determine whether glass is present.

The depth image inpainting algorithm is used to obtain reliable distance information of glass.

Steps of determining the defect point type include:
S4.1: First screen, after a depth matrix is obtained, a defect in a small scale, and record coordinates of the defect point
S4.2: For a noise point with a depth of 0, count a quantity of non-zero values in a neighboring region, where the noise point with a depth of 0 is considered to be a defect if the quantity of non-zero values is greater than a specific threshold;
S4.3: For a void with uncertain depth data, count a quantity of pieces of missing distance data in a neighboring region, where the void with uncertain depth data is considered to be a defect if the quantity of pieces of missing distance data is greater than a specific threshold; and
S4.4: For void and noise point defects, determine the defect point as the first-type defect point or the second-type defect point based on the quantity of defect points of the same type around the defect point.

For the first-type defect point, a quantity of pixels is less, and the median filtering is used for distance supplementing.

For the second-type defect point, a solution includes:
S5.1: To ensure an inpainting effect, take distance values of 24 points in the neighboring region around the defect point according to an idea of the median filtering, where if there is a void around, the distance values of the 24 points are skipped, a median of the distance values is calculated, and the median is used to assign values to points in corresponding distance values to obtain the depth matrix;
S5.2: Perform edge sharpening on the depth matrix;
S5.3: Extract boundary points from a sharpened depth matrix boundary;
S5.4: Take all points with missing distance data in the depth matrix, perform depth inpainting, and obtain an average based on distances; and
S5.5: Supplement average data to the depth matrix to obtain a final inpainted depth matrix.

A solution of map information updating includes:
S6.1: Select a minimum value in each column of the depth data to form a row vector, and perform dimension reduction processing on the inpainted depth matrix;
S6.2: Obtain a maximum value in the inpainted matrix, and calculate a current camera field-of-view range, wherein a field of view length is the maximum value in the inpainted matrix, and a field of view width and the field of view length form a trigonometric function relationship related to a lateral field of view angle;
S6.3: Obtain current pose information of a mobile robot in a world coordinate system; and
S6.4, calculating a position of an obstacle, and finally completing the map updating at the position.

The laser radar information is obtained by a depth camera.

A computer-readable storage medium stores a computer program, and the computer program, when executed by a processor in a computing device, enables the computing device to perform the method any one of the methods.

Embodiment 2: The present invention provides an indoor mobile robot glass detection and map updating method based on depth image inpainting. Further, the method includes the following specific steps:
S1: Process laser radar information to obtain strength data, and screen, based on the strength data, a region in which glass is suspected to be present;

Further, a region in which glass is suspected to be present is screened in the following manner: first analyzing received laser radar distance information, searching, based on a time stamp, based on characteristics of returned data when a laser radar scans the glass, for distance information with a single distance change that is large enough among the distance information, to trigger a detection process for the region in which glass is suspected to be present, after the process is triggered, recording the time stamp at this time, then continuously collecting the distance information in N time stamps, performing variance analysis on N pieces of data, where if a variance is great enough, a region is the region in which glass is suspected to be present, and recording the time stamps. A distance change threshold is Δₘᵢₙ. A variance threshold is Dₘₐₓ. S1 includes the following specific steps:
1. continuously calculating a difference Δ=|Dₜ₍₀₎−Dₜ₍₀₎₋₁| between two pieces of data before and after in the returned distance data, searching for a timestamp Tᵢ of returned data when the laser radar scans the glass when a distance difference Δ>Δₘᵢₙ and denoting a set of the timestamp Tᵢ as T, and recording laser radar data Gᵢ of the points and denoting a set of the laser radar data Gᵢ as G;
2. recording laser radar distance information Si at N timestamps after each point in T and denoting a set of the laser radar distance information Sᵢ as S;
3. calculating an average value Ei of data in the set S according to the following formula, and denoting the set of the average values Ei as E;

$${E}_{i} = \frac{1}{N} {\sum }_{n = 1}^{N} {S}_{i}^{n} \qquad ( 1 )$$

4. calculating a variance Di of data in the set S according to the following calculation formula, and denoting a variance set as D; and

$${D}_{i} = \frac{1}{N} {\sum }_{n = 1}^{N} {( {S}_{i}^{n} - {E}_{i} )}^{2} \qquad ( 2 )$$

5. screening out a value of Dᵢ>=Dₘᵢₙ in D, and recording an index number i and denoting the set of the index numbers i as I; and
6. selecting, based on the set I, laser radar data corresponding to the index number in G, setting the maximum length of a segment and dividing, based on time continuity, data points into a plurality of segments, and recording the segment as G_{suspect}, that is, a segment in which glass is suspected to be present.
S2: Select an image of an RGBD camera based on information of the region in which glass is suspected to be present, use a convolutional neural network to identify the image of the RGBD camera, and determine whether there is glass in the region, where absence of glass is defined as a first situation, and presence of glass is defined as a second situation;

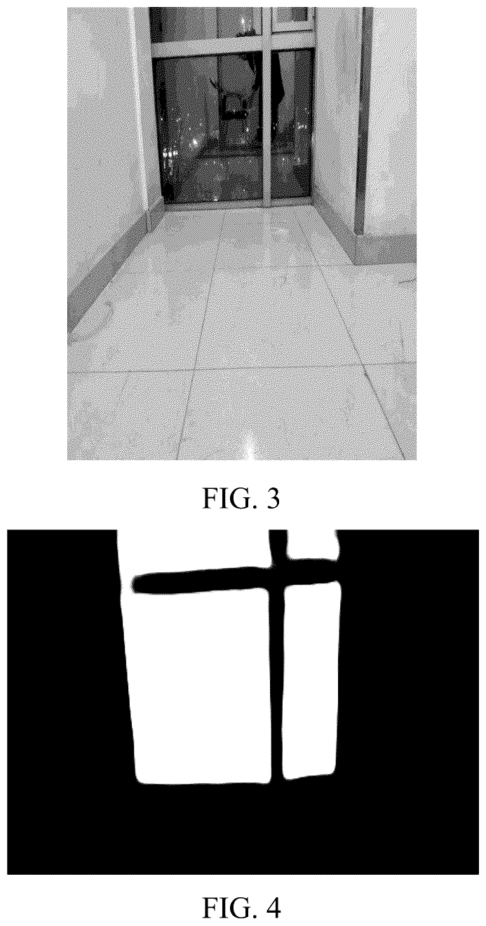

For example, a glass detection network based on deep learning is used for detection, and a core of the network is an LCFI module. The module is configured to efficiently and effectively extract and integrate multi-scale and large-scale context features under a given input feature to detect glass with different sizes. Environment RGB information (as shown in FIG. 3) is used as input image information Fᵢₙ. F_{lcfi} is an outputted detect result (as shown in FIG. 4). convᵥ represents vertical convolution having a convolution kernel size of k×₁. convₕ represents horizontal convolution having a convolution kernel size of 1×k. [symbol] represents batch normalization and linear rectification network processing. F1 is an intermediate feature extraction result. To extract a complementary large-region context feature, two types of spatially separable convolution, that is, [symbol] (convᵥ(convₕ(F₁))) and [symbol] (convₕ(convᵥ(F₁))), are used simultaneously. and conv₁ and conv₂ indicate local convolution having a convolution kernel size of 3*3. An input-output relationship may be expressed by the following formula:

$${F}_{lcfi} = 𝒳 ( {conv}_{2} ( concat ( 𝒳 ( {conv}_{v} ( {conv}_{h} ( {F}_{1} ) ) ) , 𝒳 ( {conv}_{h} ( {conv}_{v} ( {F}_{1} ) ) ) ) ) ) \qquad ( 3 )$$

$${F}_{1} = 𝒳 ( {conv}_{1} ( {F}_{in} ) )$$

F_{lcfi} represents an image feature obtained by convolution. It cannot be directly determined whether glass is present in the step. Then, four LCFI modules are used to extract different levels of features for summarizing and convolving. Next, a sigmoid function is used to activate features to output a value between 0 and 1, that is, a probability of determining whether glass is present. In addition, boundary information of glass may be obtained, and the boundary information is used for depth inpainting of a glass region in a next step.
S3: Normally perform, when a result is the first situation, map updating without inpainting;
S4: Determine, when the result is the second situation, a defect point type in depth data obtained by the RGBD camera, where using a pixel as a center, if a quantity of defect points of a same type within a 5×5 range is less than or equal to 12, it is determined that the pixel is a first-type defect point, or if a quantity of defect points of a same type within a 5×5 range is greater than 12, it is determined that the pixel is a second-type defect point. The range is a preferred embodiment, and a problem of division and subsequent identification of defect points may also be solved based on a quantity of defect points with similar proportions in another range. For example, when a neighboring region area is 10×10, the first threshold is 50, not affecting an implementation of the technical effect of the present invention.

Further, there are two reasons for a void. One reason is that, infrared light emitted by the camera directly penetrates glass and cannot return to the camera, so that a distance of the glass obstacle is unknown. In this case a void area is large, and the area is generally flat. The other reason is that the void is caused by an inaccurate depth value of an object pixel. In this case, a void area is small and usually a single pixel. In addition to the void, when the depth image data is obtained, there are some noise points with a depth value of 0 due to reflection on a physical surface, when an edge of an object is measured. Determining steps include:
1. first screening, after a depth matrix P is obtained, a defect in a small scale, and recording coordinates of the defect point and denoting the coordinates of the defect point as S_{bad};
2. for a noise point with a depth of 0, counting a quantity of non-zero values in all 3×3 and 5×5 neighboring regions of the noise point with a depth of 0, where the noise point with a depth of 0 is considered to be a defect if the quantity of non-zero values is greater than a specific threshold; and
3. for a void with uncertain depth data, counting a quantity of pieces of missing distance data in all 3×3 and 5×5 neighboring regions of the point with missing distance data, where the void with uncertain depth data is considered to be a defect if the quantity of pieces of missing distance data is greater than a specific threshold.
S5, performing supplementing, when the defect point is the first-type defect point, by using median filtering, or first detecting, when the defect point is the second-type defect point, a defect edge and then calculating, based on a linear filtering idea, distance values around a pixel to perform supplementing; and

For defects such as the void and noise point, based on a defect area, median filtering is used to perform distance supplementing on a defect that is usually less than the threshold. For a defect that is greater than the threshold, a defect edge is first detected, and distance values around a pixel are calculated based on a linear filtering idea to perform the supplementing. Specific steps are as follows: A solution of inpainting the defect point is as follows:
1. performing the distance supplementing on a point in S_{bad}, and to ensure an inpainting effect, taking distance values of 24 points in the neighboring region of 5×5 around the defect point according to an idea of the median filtering and denoting the distance values as D_{bad}, where if there is a void around, the distance values of the 24 points are skipped, a median D_{mid} of D_{bad} is calculated, and D_{mid} is used to assign values to points in corresponding S_{bad} to obtain a depth matrix P₁;
2. performing edge sharpening on P₁ to ensure an effect of subsequent boundary extraction, and denoting a sharpened depth matrix as P₂;
3. performing boundary extraction on P₂, and denoting a set of boundary points as E;
4. taking all points with missing distance data in P₁, and denoting the points as B, performing depth inpainting by searching for nearest boundary points in four directions of up, down, left, and right of the defect point in E¹ and denoting the nearest boundary points as E_{w}, Eₛ, E_{A}, and E_{D}, calculating distances between the to-be-inpainted point and the corresponding four boundary points and respectively denoting the distances as d_{w}, dₛ, d_{A}, and d_{D}, and finding distance data, that is, P₁^{E}^{_{W}}, P₁^{E}^{_{S}}, P₁^{E}^{_{A}}, and P₁^{E}^{_{D}} of the corresponding points in P₁ to calculate an average based on distances according to the following formula:

$${P}_{1}^{B} = \frac{( {d}_{A} + {d}_{D} ) ( {d}_{W} {P}_{1}^{{E}_{S}} + {d}_{S} {P}_{1}^{{E}_{W}} )}{( {d}_{W} + {d}_{S} + {d}_{A} + {d}_{D} ) ( {d}_{W} + {d}_{S} )} + \frac{( {d}_{W} + {d}_{S} ) ( {d}_{D} {P}_{1}^{{E}_{A}} + {d}_{A} {P}_{1}^{{E}_{D}} )}{( {d}_{W} + {d}_{S} + {d}_{A} + {d}_{D} ) ( {d}_{A} + {d}_{D} )} \qquad ( 4 )$$

5. supplementing data P₁^{B} to the depth matrix P₁ to obtain a final inpainted depth matrix P_{f}.

For example, after it is determined that there is glass in the place by using F_{lcfi}, depth information is called to inpaint a glass image. An effect of the depth image is poor, and in this experiment, an inpainting process performed on the depth image in the following steps is shown in the form of a gray map.

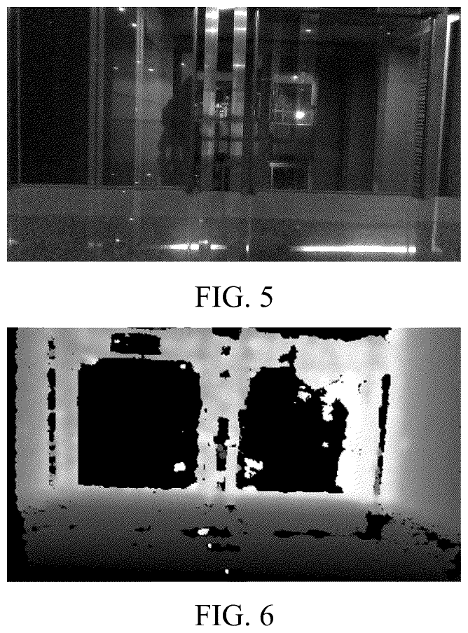

An original RGB picture obtained by the camera in the inpainting experiment are shown in FIG. 5, and the depth image matrix P (as shown in FIG. 6) is obtained. First, a defect is screened in a small scale and coordinates of the defect point are recorded.

For a noise point with a depth of 0, a quantity of non-zero values in all 3×3 and 5×5 neighboring regions of the noise point with a depth of 0 is counted, where the noise point with a depth of 0 is considered to be a defect if the quantity of non-zero values is greater than a specific threshold.

For a void with uncertain depth data, a quantity of pieces of missing distance data in all 3×3 and 5×5 neighboring regions of the point with missing distance data is counted, where the void with uncertain depth data is considered to be a defect if the quantity of pieces of missing distance data is greater than a specific threshold.

The distance supplementing is performed on the defect point in the small scale. To ensure an inpainting effect, distance values of 24 points in the neighboring region of 5×5 around the defect point are taken based on an idea of the median and a median of the distance values is calculated. If there is a void around, the distance values are skipped, and the corresponding defect point in the small scale is assigned with the median to obtain the depth matrix P₁ (as shown in FIG. 7).

A sharpening operation is performed on P₁ to ensure an effect of subsequent boundary extraction, and an extracted depth matrix is denoted as P₂.

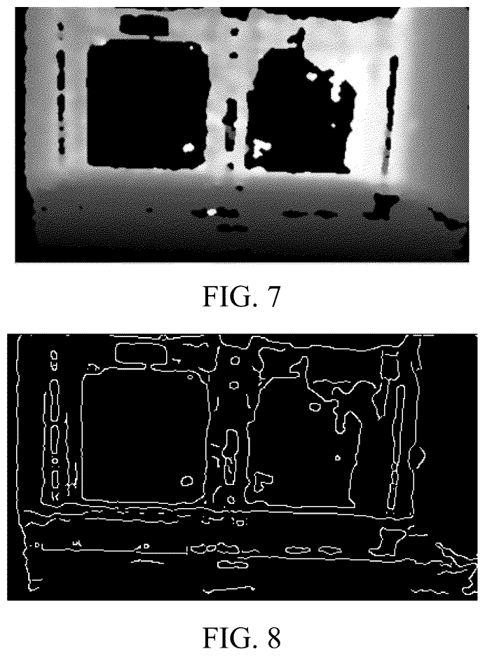

Boundary extraction is performed on P₂, and a set of boundary points is denoted as E. A depth extraction process is shown in FIG. 8.

All points with missing distance data in P₁ are taken, and the points are denoted as B. Depth inpainting is performed by searching for nearest boundary points in four directions of up, down, left, and right of the defect point in E¹ and the nearest boundary points are denoted as E_{w}, Eₛ, E_{A}, and E_{D}. Distances between the to-be-inpainted point and the corresponding four boundary points are calculated and the distances are respectively denoted as d_{w}, dₛ, d_{A}, and d_{D}. Distance data, that is, P₁^{E}^{_{W}}, P₁^{E}^{_{S}}, P₁^{E}^{_{A}}, P₁^{E}^{_{D}}, of the corresponding points in P₁ is found to calculate an average based on distances according to the following formula:

$${P}_{1}^{B} = \frac{( {d}_{A} + {d}_{D} ) ( {d}_{W} {P}_{1}^{{E}_{S}} + {d}_{S} {P}_{1}^{{E}_{W}} )}{( {d}_{W} + {d}_{S} + {d}_{A} + {d}_{D} ) ( {d}_{W} + {d}_{S} )} + \frac{( {d}_{W} + {d}_{S} ) ( {d}_{D} {P}_{1}^{{E}_{A}} + {d}_{A} {P}_{1}^{{E}_{D}} )}{( {d}_{W} + {d}_{S} + {d}_{A} + {d}_{D} ) ( {d}_{A} + {d}_{D} )}$$

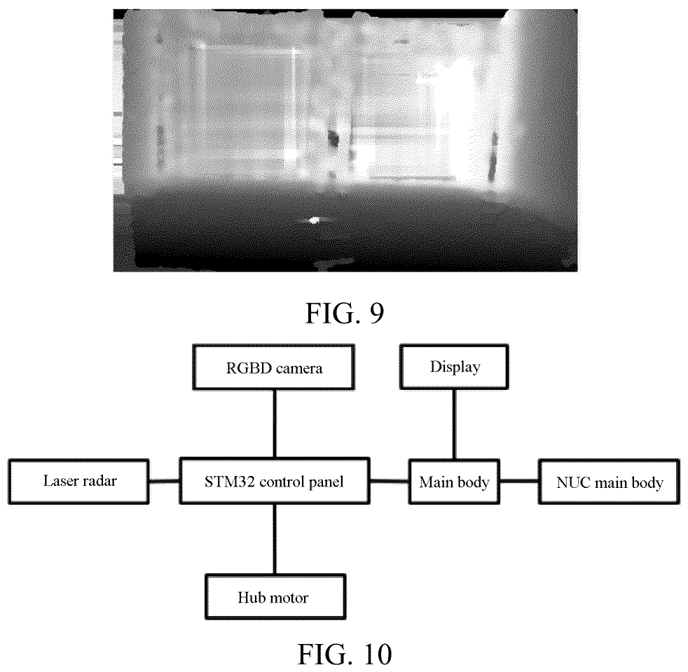

Data P₁^{B} is supplemented to the depth matrix P₁ to obtain a final inpainted depth matrix PB Pf (as shown in FIG. 9).
S6: Perform plane sampling on an inpainted depth image to obtain reliable distance data, and output the distance data to a map updating step to obtain an inpainted new map for planning.

Further, an inpainted depth matrix is a two-dimensional matrix, and corresponds to the distance information of the points on a plane perpendicular to a map. Therefore, to realize a function of distance data supplementing, first, it is necessary to perform dimension reduction processing on the distance information. Then, in combination with depth data obtained through the dimension reduction, original grid map data is supplemented within a depth measurement range of an RGBD camera. For a position of an obstacle in an original direction, depth data is directly used for supplementing, and if there is an obstacle in the original direction, a distance difference threshold & is set. Once a difference between the distance of the original map obstacle and depth data exceeds the threshold, to ensure safety of a planned path, a smaller value is selected to display the obstacle. Alternatively, if a difference between the distance of the original map obstacle and depth data is less than the threshold, distance data of the distance and the depth data are combined, and a new distance value d_{gauss} is obtained based on the idea of Gaussian filtering to be supplemented the map. Specific selection steps are as follows:
1. first performing dimension reduction processing on the inpainted depth matrix P_{f}, where the processing method is to select a minimum value in each column of depth data to form a row vector d_{camera} to ensure safety;
2. obtaining a maximum value P_{f}^{max} of the matrix P_{f}, and calculating a current camera field of view, where if a lateral field of view angle of the camera is γ, the calculation method of a field of view length a and a field of view width b is as follows:

$$\{ \begin{matrix}a = {P}_{f}^{max} \\ b = 2 atan \frac{γ}{2}\end{matrix} \qquad ( 5 )$$

3. taking a forward included angle between a selected camera and a mobile robot as β, where β is related to a quantity n of RGBD cameras placed by the mobile robot, n is determined based on a value of γ, a range of 360° needs to be covered as much as possible, and the calculation method of β is as follows:

$$β = Camera number \times \frac{360 °}{n} \qquad ( 6 )$$

4. obtaining current pose information (X . . . y◯j) of the mobile robot in a world coordinate system, and calculating a line I(x₀, y₀, θ, β) in which a plane projection of the camera is located:

$$I ( {x}_{0} , {y}_{0} , θ , β ) : y = {y}_{0} + ( x - {x}_{0} ) tan ( θ + β ) \qquad ( 7 )$$

5. framing all grids in a range of a*b in front of the camera at the selected depth, and recording coordinates of the grids displayed as being occupied in the range as L_{obstacle}; and calculating distances from the grids to line 1 and denoting the distances as d_{obstacle};
6. using d_{camera} to obtain the coordinates of the obstacle in the camera, denoting a length of d_{camera} as m, and traversing d_{obstacle} from left to right, where a calculation formula of the coordinates of the obstacle is as follows:

$$\{ \begin{matrix}{x}_{m} = {x}_{0} + {d}_{camera}^{m} cos ( θ + β + \frac{γ}{2} - \frac{{γ}_{m}}{M} ) \\ {y}_{m} = {y}_{0} + {d}_{camera}^{m} {sin ( θ + β + \frac{γ}{2} - \frac{{γ}_{m}}{M} )}_{( 8 )}\end{matrix} \qquad ( 8 )$$

7. searching for coordinates of a point with a shortest distance L_{obstacla}^{m} in L_{obstacla} where a line connecting (xₘ, yₘ) and L_{obstacla}^{m} is perpendicular to the line l, denoting the distance data as d_{obstacle}^{m}, comparing d_{obstacle}^{m} with d_{camera}^{m}, to calculate the position of the obstacle.

If, |d_{obstacle}^{m}−d_{camera}^{m}|≥ε, to be specific, there is a great difference between camera inpainting distance data and laser radar data, (8) is used to calculate the distance data.

The smaller distance to the line 1 is taken as the obstacle information, and if d_{camera}^{m} is selected, (xₘ, yₘ) is set as being occupied in the grid map. Alternatively, if d_{camera}^{m} is not selected, the grid map remains unchanged.

If |d_{obstacle}^{m}−d_{camera}^{m}|<ε, to be specific, there is a small difference between camera inpainting distance data and laser radar data, (9) is used to calculate the distance data:

Obstacle information is calculated according to the following rules:

$$\{ \begin{matrix}{d}_{gauss} = ρ {d}_{obstacle}^{m} - δ {d}_{camera}^{m} ( ρ + δ = 1 ) \\ {x}_{r} = {x}_{0} + {d}_{gauss} cos ( θ + β + \frac{γ}{2} - \frac{γ m}{M} ) \\ {y}_{r} = {y}_{0} + {d}_{gauss} sin ( θ + β + \frac{γ}{2} - \frac{γ m}{M} )\end{matrix} \qquad ( 9 )$$

Values of ρ and δ may be modified based on confidence of the laser radar data and camera data. After the point L_{obstacla}^{m} in the grid map is changed as being unoccupied, (x_{gauss}, y_{gauss}) is set as being occupied. After d_{camera} is traversed, the map is finally updated.

In the method, laser radar and camera data are used to accurately detect glass. The laser radar has high stability and a wide range of visual field information can be obtained, while the camera receives the data in a visual field of the camera comprehensively, but the visual field is narrow. No matter at what distance, when the laser radar screens glass, the distance data is unreliable. Formula (9) is a special reliable situation of a specific point of the laser radar data, and at the point, the laser radar data is very close to the inpainted distance data. In this case, a distance is a weighted average of the laser radar data and the inpainted distance data, and weight distribution is related to a mapping effect of the laser radar around the position in the original map. If the effect is poor, the weight of the laser radar should be reduced. According to formula (9), weights of laser radar data and camera data under different situations are adjusted to meet a confidence interval in which the laser radar data and camera data information can be fully utilized, improving a utilization rate of data and further improving accuracy of identifying a position of an obstacle with glass.

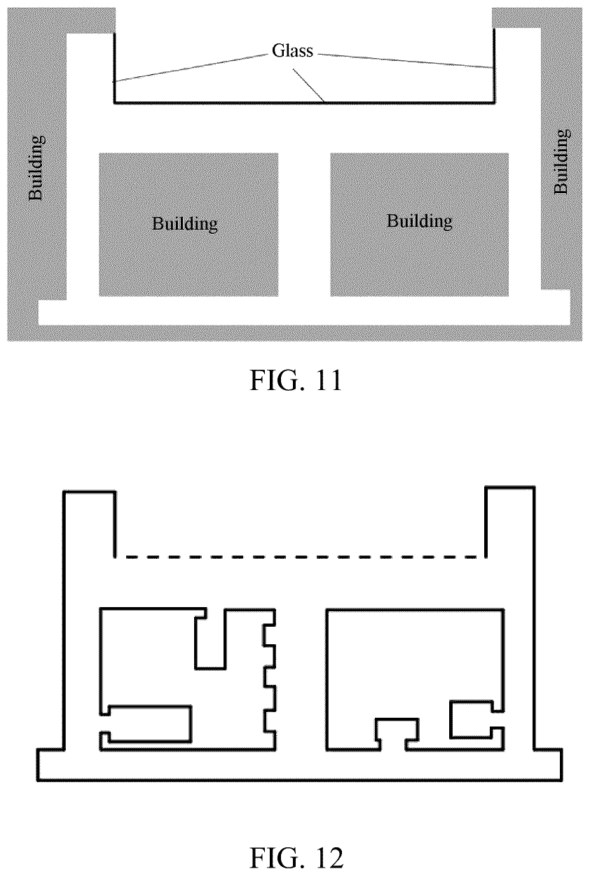

To verify feasibility of the solution, an autonomous updating experiment of robot navigation map is performed. The experiment is performed in an office environment of a teaching building (as shown in FIG. 11) by using a mobile platforms (where platform composition is shown in FIG. 10) with an odometer, a single-line laser radar and five RGBD camera.

A platform hardware models are as follows:
Laser radar radium: Leishen N301
RGBD camera: IntelRealSenseDepthCameraD435i
Odometer: Hub motor with encoder
Microprocessor: Intel NUC7i5BNK

The environment mainly includes a corridor and glass. One circle of the corridor is close to an external wall of the teaching building, so that one side is a wall and the other side is a glass fence. There is no restriction or control such as lighting and marking during the experiment. First, the mobile platform is used to run a Gmapping program in the environment for SLAM. In addition, the camera is turned on to obtain environmental information, all information sets are stored as rosbag, and the map is updated by using rosbag.

The environment map is initially established as shown in FIG. 12. After the map is analyzed, it may be found that only a glass frame is detected in a glass region, indicating that a laser radar-based Gmapping algorithm has a clear problem of glass perception failure, and it is not feasible to use the map for path planning. The navigation map is updated below to supplement the glass obstacle information on the map.

First, a region in which glass is suspected to be present is determined. Received laser radar distance information is analyzed. Based on a time stamp, based on characteristics of returned data when a laser radar scans the glass, distance information having a large enough single distance change in the distance information is searched, to trigger a detection process for the region in which glass is suspected to be present. After the process is triggered, the time stamp at this time is recorded, then the distance information in 30 time stamps is continuously collected, variance analysis is performed on 30 pieces of data, where if a variance is great enough, a region is the region in which glass is suspected to be present, and the time stamps are recorded.

Angle information corresponding to the regions are found based on the time stamps, and the angle information is used to find data corresponding to an RGBD camera at corresponding time. The specific method is to use the angle information to find a remainder of 360 degrees. For the five RGBD cameras, each camera corresponds to 72 degrees, and each camera has an own angle range. RGBD data of the region may be found by finding a range of an angle remainder.

Then, according to Example 1, it is determined whether the glass region exists and a boundary of the glass region is extracted, and depth inpainting of the glass region is completed. The inpainted depth matrix is a two-dimensional matrix. During inpainting, a threshold for screening noise points or voids with an uncertain depth is 60%. To be specific, when there are 18 noise points or voids in a range of 5×5 and 6 noise points or voids in a range of 3*3, it is considered that there is a defect in a small range.

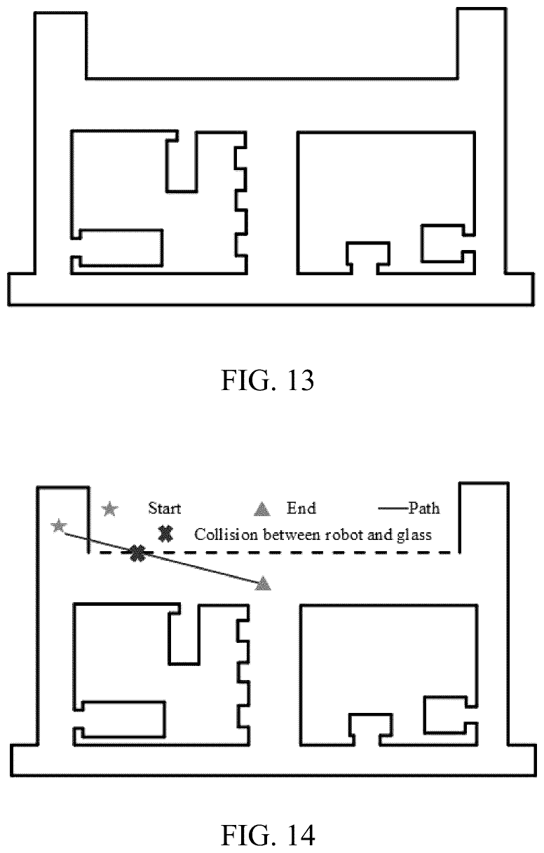

Inpainted depth information corresponds to the distance information of the points on a plane perpendicular to a map. Therefore, to realize a function of distance data supplementing, dimension reduction processing is performed on the distance information. Then, in combination with depth data obtained through the dimension reduction, original grid map data is supplemented within a depth measurement range of an RGBD camera. For a position of an obstacle in an original direction, depth data is directly used for supplementing, and if there is an obstacle in the original direction, a distance difference threshold is set to 50 mm. Once a difference between the distance of the original map obstacle and depth data exceeds the threshold, to ensure safety of a planned path, a smaller value is selected to be displayed as an obstacle. Alternative, if a difference between the distance of the original map obstacle and depth data is less than the threshold, distance data of the distance and the depth data are combined, and a new distance value is obtained based on an improved Gaussian filtering method to be supplemented the map. As shown in FIG. 13, a region grid between glass frames in the environment has been marked as being occupied, and a result obtained by using the map for planning and path optimization (Embodiment 3) are reliable and available, proving feasibility of the method.

To verify superiority of the solution, comparative experiments of path optimization and obstacle avoidance are performed. The mobile robot platform as shown in FIG. 10 is used to perform a path planning experiment in the office environment of the teaching building as shown in FIG. 11, and an initially established map (FIG. 12) and an inpainted map (FIG. 13) are used to perform the path planning experiment. The established map is exported to MATLAB 2020B in the experiment. A detailed configuration of a computer based on A* algorithm is as follows:
CPU: AMD Ryzen 7 5800H
Memory: 16 GB
Hard disk: 512 G high-speed solid-state hard disk

First, point-to-point path planning is performed in the original map, and starting point coordinates are set as (125, 125), that is, a triangle landmark point, and ending point coordinates are set as (180, 440), that is, a polygon landmark point. A result is shown in FIG. 14. A planned path directly passes through the glass region. The path leads to a serious collision between a robot and a glass curtain wall during operation, resulting in damage to an experimental device and even injury to an experimenter.

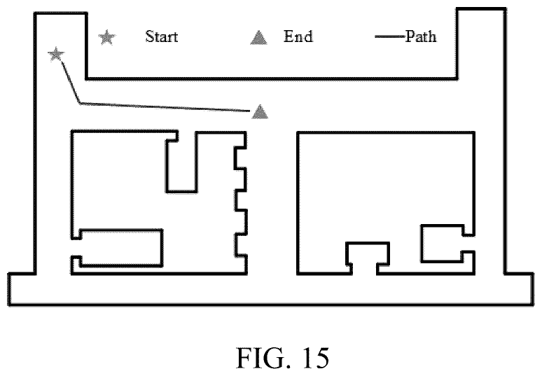

Then, point-to-point path planning is performed in an updated and inpainted map based on the glass information. The starting point coordinates are also set to (125, 125) and the ending point coordinates are set to (180, 440). A planning result is shown in FIG. 15, and the glass region is completely bypassed in the planned path. The experimental result shows that the updated map with glass inpainting is used to perform path planning experiment, greatly improving path quality compared to the original map, and avoiding a glass obstacle well to ensure safety of robot operation. In addition, it indicates that the present invention has a good effect in path optimization and obstacle avoidance in an actual environment.

According to the method, by processing laser radar information, screening a region in which glass is suspected to be present, selecting an RGBD camera image, and using a convolutional neural network to identify the RGBD camera image, multi-scale and large-scale context features are efficiently and effectively extracted and integrated, thereby improving accuracy of glass identification. A defect point type in depth data obtained by the RGBD camera is determined, and median filtering or linear filtering is used to separately perform inpainting for the defect point type, to improve an inpainted effect and further improve accuracy of glass identification. When the coordinates of the obstacle are calculated, weights of laser radar data and camera data under different effects of the mapping around the position in the original map are adjusted to meet a confidence interval in which the laser radar data and camera data information can be fully utilized, improving a utilization rate of data, further improving accuracy of identifying a position of an obstacle with glass, and comprehensively improving effective identification of obstacle information.

The present invention provides an indoor mobile robot glass detection and map updating method based on depth image inpainting. The method includes: first screening, based on a laser radar intensity data variance, a region in which glass is suspected to be present; determining, based on an RGB image of the suspected region and by using a convolutional neural network, whether glass is really present; if glass is really present, extracting a glass region boundary, determining a defect point of a depth image, and performing depth information supplementing on the defect point based on the glass region boundary; and finally, performing plane sampling on the depth image, inpainting and updating a glass obstacle missing in an original map, and outputting a grid map for planning. Therefore, a problem, that the existing mapping algorithms and devices are prone to glass perception failure due to the characteristics of glass transmission, refraction, polarization, etc., affecting the map integrity and navigation safety, is solved. The present invention has advantages of a low system perception cost and a safe and stable navigation function.

The foregoing embodiments are merely exemplary descriptions for explaining the principle of the present invention. However, the present invention is not limited thereto. The system and method disclosed this time can be encapsulated into a single algorithm or functional group and embedded in existing mobile robot clients, facilitating using for a customer and an equipment operation and maintenance personnel. For a person of ordinary skill in the art, various transformation and improvements can be made without departing from the spirit and essence of the present invention, and the variations and improvements are also regarded as the protection scope of the present invention.

1. An indoor mobile robot glass detection and map updating method based on depth image inpainting, comprising:
S1, processing laser radar information to obtain laser radar distance data, and screening, based on the distance data, a region in which glass is suspected to be present;
S2, selecting an image of an RGBD camera based on information of the region in which glass is suspected to be present, using a convolutional neural network to identify the image of the RGBD camera, and determining whether there is glass in the region, defining an absence of glass as a first situation, and defining a presence of glass as a second situation;
S3, normally performing, when a result is the first situation, map updating without inpainting;
S4, determining, when the result is the second situation, a defect point type in depth data obtained by the RGBD camera, wherein using the defect point as a center, if a quantity of defect points of a same type in a neighboring region is less than or equal to a first threshold, it is determined that the defect point is a first-type defect point, or if a quantity of defect points of the same type in the neighboring region is greater than a first threshold, it is determined that the defect point is a second-type defect point;
S5, performing supplementing, when the defect point is the first-type defect point, by using a median filtering, or first detecting, when the defect point is the second-type defect point, a defect edge and then calculating distance values between the defect point and around the defect point to perform supplementing; and
S6, performing plane sampling on an inpainted depth image to obtain distance data, and outputting the distance data to a map updating step to obtain an inpainted new map for planning, wherein
S1 comprises:
S1.1, defining a distance change threshold and a variance threshold;
S1.2, continuously calculating a difference Δ=|D₍₀₎−Dₜ₍₀₎₋₁| between two pieces of data before and after in the returned distance data, searching for a timestamp Ti in which a distance difference is greater than the distance change threshold and denoting a set of the timestamp Ti as T, recording laser radar data Gi of these points and denoting a set of the laser radar data Gi as G, and recording laser radar distance information Si of N timestamps after the points in T and denoting a set of the laser radar distance information Si as S;
S1.3, calculating an average value Ei of data in the set S according to the following formula, and denoting the set of the average value Ei as E;
$${E}_{i} = \frac{1}{N} {\sum }_{n = 1}^{N} {S}_{i}^{n} \qquad ( 1 )$$
calculating a variance Di of data in the set S according to the following calculation formula, and denoting a variance set as D; and
$${D}_{i} = \frac{1}{N} {\sum }_{n = 1}^{N} {( {S}_{i}^{n} - {E}_{i} )}^{2} \qquad ( 2 )$$
recording data corresponding to a timestamp exceeding the variance threshold and screening out a value of Dᵢ>=Dₘᵢₙ in D, and recording its index number i and denoting the set of the index number i as I; and
S1.4, selecting, based on the set I, laser radar data corresponding to the index number in G, setting a maximum length of a segment and dividing, based on time continuity, data corresponding to the timestamp exceeding the variance threshold into a plurality of segments, and recording the segment as Gsuspect, that is, a segment in which glass is suspected to be present.

2. The indoor mobile robot glass detection and map updating method based on depth image inpainting according to claim 1, wherein RGBD image detection is introduced and an RGB image is used to determine whether glass is present.

3. The indoor mobile robot glass detection and map updating method based on depth image inpainting according to claim 1, wherein steps of determining the defect point type comprise:
S4.1, first screening, after a depth matrix is obtained, a defect in a small scale, and recording coordinates of the defect point;
S4.2, counting a quantity of non-zero values in a neighboring region of a noise point with a depth of 0, wherein the noise point with the depth of 0 is considered to be a defect if the quantity of non-zero values is greater than a threshold;
S4.3, counting a quantity of pieces of missing distance data in a neighboring region of a void with uncertain depth data, wherein the void with uncertain depth data is considered to be a defect if the quantity of pieces of missing distance data is greater than the threshold; and
S4.4, for void and noise point defects, determining the defect point as the first-type defect point or the second-type defect point based on the quantity of defect points of the same type around the defect point.

4. The indoor mobile robot glass detection and map updating method based on depth image inpainting according to claim 3, wherein the quantity of defect points of the same type in the neighboring region of the first-type defect point is less than or equal to the first threshold, and the median filtering is used for distance supplementing.

5. The indoor mobile robot glass detection and map updating method based on depth image inpainting according to claim 3, wherein a solution of inpainting the second-type defect point comprises:
S5.1, to ensure an inpainting effect, taking distance values of 24 points in the neighboring region around the defect point according to an idea of the median filtering, wherein if there is a void around, the distance values of the 24 points are skipped, a median of the distance values is calculated, and the median is used to assign values to points in corresponding distance values to obtain the depth matrix;
S5.2, performing edge sharpening on the depth matrix;
S5.3, extracting boundary points from a sharpened depth matrix boundary;
S5.4, taking all points with missing distance data in the depth matrix, performing depth inpainting, and obtaining a distance average based on distances and distances to nearest boundary points; and
S5.5, supplementing average data to the depth matrix to obtain a final inpainted depth matrix.

6. The indoor mobile robot glass detection and map updating method based on depth image inpainting according to claim 5, wherein steps of map updating comprise:
S6.1, selecting a minimum value in each column of the depth data to form a row vector, and performing dimension reduction processing on the inpainted depth matrix;
S6.2, obtaining a maximum value in the inpainted depth matrix, and calculating a current camera field-of-view range, wherein a field of view length is the maximum value in the inpainted depth matrix, and a field of view width and the field of view length form a trigonometric function relationship related to a lateral field of view angle;
S6.3, obtaining current pose information of a mobile robot in a world coordinate system; and
S6.4, calculating a position of an obstacle, and finally completing the map updating at the position.

7. The indoor mobile robot glass detection and map updating method based on depth image inpainting according to claim 1, wherein the laser radar information is obtained by a depth camera.

8. A computer-readable storage medium, storing a computer program, wherein the computer program, when executed by a processor in a computing device, enables the computing device to perform the method according to claim 1.
